(19) United States
(12) Patent Application Publication
(10) Pub. No.: US 2022/0391700 A1
(43) Pub. Date: Dec. 8, 2022

(54) Method and Device for Training an Energy Management System in an On-Board Energy Supply System Simulation

(71) Applicant: Bayerische Motoren Werke Aktiengesellschaft, Muenchen (DE)

(72) Inventors: Fabian GRAF, Muenchen (DE); Andreas HEIMRATH, Emmering (DE)

(21) Appl. No.: 17/775,911

(22) PCT Filed: Oct. 23, 2020
(86) PCT No.: PCT/EP2020/079942

§ 371 Date: May 11, 2022

(30) Foreign Application Priority Data
Nov. 11, 2019 (DE) 10 2019 130 393.1

(51) Int. Cl. G06N 3/08; B60R 16/033; H01M 10/42

(52) U.S. Cl. CPC G06N 3/08; B60R 16/033; H01M 10/425; H01M 2010/4271; H01M 2220/20

(57) ABSTRACT

A method and device for training an energy management system in an on-board energy supply system simulation, includes: simulating a driving cycle having defined recuperation; plotting state variables of the on-board energy supply system; calculating a recuperation power from a recu-peration current and a battery voltage; producing input vectors for a neural network; producing a reward function; and training the neural network.

### BACKGROUND AND SUMMARY

The present invention relates to a method and to a device for training an energy management system in an on-board energy system simulation.

The complexity of the electrical on-board energy system in motor vehicles has increased considerably due to the constantly increasing functional scopes and an ever-increasing number of electronic components and subsystems. Not only have the requirements in terms of comfort and safety of a vehicle increased significantly, but far greater requirements in terms of energy efficiency and climate compatibility are also present, these being able to be achieved only using complex electronic regulation and control systems, for example in the field of engine control and exhaust gas treatment. New types of driver assistance systems are furthermore becoming established for a wide variety of driving situations, from an electronic emergency braking assistant to automatic parking systems as far as fully autonomous driving.

These systems are linked to additional controllers and also to higher efficiency reliability requirements on the on-board energy system. This is exacerbated by multi-voltage on-board systems in a variety of designs, high-voltage systems in the region of the electric drive, redundant supply architectures for automatic driving and an enormous number of possible configuration variants in the case of premium vehicles that require a complex architecture and an individual design of the on-board system. The interaction between the subsystems and on-board power systems becomes a complex coordination task. The use of simple, rule-based operating strategies for electrical energy management is therefore getting ever closer to its limits.

Machine learning is an important approach for mastering complexity and the variety of variants, because there is no need for an explicit description of all system states and the associated rules, but rather the underlying models are generalized on the basis of training data and learning processes and predictions are able to be made for previously unknown system states. One such approach is reflex-augmented reinforcement learning that makes it possible to learn operating strategies for electrical energy management in the vehicle and to master complex and previously unknown system states using artificial intelligence means. In this concept, decisions regarding the energy management in the vehicle are made by what is known as an agent in accordance with an operating strategy that said agent learns. What is known as a reflex secures and stabilizes the system by virtue of a decision proposed by agents regarding energy management being implemented only when it is accepted by the reflex. At the same time, the agent receives feedback in the form of what is known as a reward in accordance with a reward function, the function value of which depends on the effects of the proposed decision and possibly on the intervention of the reflex. The reward function is used during the learning process in order to orient the operating strategy to the desired optimization targets. The expansion by the reflex allows the use of reinforcement learning in safety-relevant systems.

The concept of reflex-augmented reinforcement learning is known from the following documents:

A. Heimrath, J. Froeschl, and U. Baumgarten, “Reflex-augmented reinforcement learning for electrical energy management in vehicles”, Proceedings of the 2018 International Conference on Artificial Intelligence, H. R. Arabnia, D. de la Fuente, E. B. Kozorenko, J. A. Olivas, and F. G. Tinetti, Eds. CSREA Press, 2018, pp. 429-430;

A. Heimrath, J. Froeschl, R. Rezaei, M. Lamprecht, and U. Baumgarten, “Reflex-augmented reinforcement learning for operating strategies in automotive electrical energy management”, Proceedings of the 2019 International Conference on Computing, Electronics & Communications Engineering (iCCECE), IEEE, 2019, pp. 62-67;

A. Heimrath, J. Froeschl, K. Barbehoen, and U. Baumgarten, “Kunstliche Intelligenz für das elektrische Energiemanagement: Zukunft kybernetischer Managementsysteme” [Artificial intelligence for electrical energy management: the future of cybernetic management systems], Elektronik Automotive, pp. 42-46, 2019.

Document DE 10 2017 214 384 A1 discloses how an operating strategy profile for the operation of a vehicle should be defined through the transmission of route data and how a global, geo-referenced operating strategy profile in relation to a route should be defined using a central database device.

Document DE 10 2016 200 854 A1 discloses how a classifier is dimensioned, which classifier is designed to assign a value of a feature vector to one class from at least two different classes on the basis of ascertaining sample values and synthetic values generated therefrom.

One object of the invention is to provide a method and a device for training an energy management system in an on-board energy system simulation.

The object is achieved by methods and devices according to the independent claims.

A first aspect of the invention relates to a method for training an energy management system in an on-board energy system simulation, in particular in a simulation of an on-board energy system of a motor vehicle, comprising (a) simulating a driving cycle with defined recuperation; (b) recording state variables of the on-board energy system; (c) calculating a recuperation power P_{recu} from a recuperation current I_{recu} and a battery voltage U_{bat} in accordance with the formula P_{recu}=U_{bat}·I_{recu}; (d) generating input vectors S of a neural network N; (e) generating a reward function; and (f) training the neural network.

One advantage of the invention is that an energy management system is able to receive an initial operating strategy for a standard configuration variant through initial training in an on-board energy system simulation prior to delivery of a vehicle. Proceeding from this functional state, the operating strategy may be adapted to additional consumers in accordance with the optimization criteria.

A WLTP driving cycle with defined recuperation is preferably used for the initial training of the energy management system.

In one preferred embodiment, the recuperation current I_{recu} is determined using a following procedure, comprising (a) extracting all of the grid points of a battery current profile I_{bat} that are able to be attributed to decisions of the energy management system and have not been impressed externally on the on-board energy system; (b) smoothing the battery current profile I_{bat} between the remaining grid points; (c) approximating the battery current profile I_{bat} through an approximated battery current profile Iₐₚₚᵣₒₓ between the remaining grid points; and (d) calculating the recuperation current I_{recu} from the battery current I_{bat} and the approximated battery current Iₐₚₚᵣₒₓ in accordance with the formula I_{recu}=I_{bat}−Iₐₚₚᵣₒₓ.

The calculation of the recuperation current in relation to the previous system behavior of the on-board energy system influences the learning behavior of the neural network.

On the other hand, it is easier to implement a further preferred embodiment in which the recuperation current I_{recu} corresponds directly to the battery current I_{bat}.

In a further preferred embodiment, input vectors S of a neural network N are generated using a following procedure, comprising (a) generating a state input vector Sₙₒᵣₘₐₗ of a neural network N; and (b) expanding the state input vector Sₙₒᵣₘₐₗ of a neural network N with a state vector S_{expanded}.

$${S}_{normal} = [ \begin{matrix}Generator degree of use \\ Normalized battery current \\ SoC \\ Battery temperature\end{matrix} ] S = [ \begin{matrix}{S}_{normal} \\ {S}_{expanded}\end{matrix} ]$$

In a further preferred embodiment, generating the state vector S_{expanded} comprises (a) calculating recuperation energy values E_{recu,x} by integrating a recuperation power P_{recu}(t) over time t, from a current time to within the driving cycle to a time t₀+x·tᵥₛ, wherein x is a percentage share of a look-ahead time tᵥₛ for a limited future consideration of recuperation powers P_{recu}(t) and (b) generating a state vector S_{expanded} that comprises at least the recuperation energy values E_{recu,25%}, E_{recu,50%}, E_{recu,75%} and E_{recu,100%}.

$${E}_{recu ′ x} ( {t}_{0} ) = {\int }_{{t}_{0}}^{{t}_{0} + x . {t}_{vs}} {P}_{recu} dt \qquad {S}_{expanded} = [ \begin{matrix}{E}_{recu , 25 \%} \\ {E}_{recu , 50 \%} \\ {E}_{recu , 75 \%} \\ {E}_{recu , 100 \%}\end{matrix} ]$$

In a further preferred embodiment, generating the state vector S_{expanded} comprises (a) calculating a center of gravity tₛₚ of a power distribution and a predicted recuperation energy value E_{recu,100%} within a look-ahead time tᵥₛ, wherein the center of gravity is that point at which the integral over the recuperation power within the look-ahead time tᵥₛ takes on half the overall recuperation energy; and (b) generating a state vector S_{expanded} that comprises the predicted recuperation energy value E_{recu,100%} and the center of gravity tₛₚ of the power distribution.

$${\int }_{{t}_{0}}^{{t}_{0} + {t}_{sp}} {P}_{recu} ( t ) dt = {\int }_{{t}_{0} + {t}_{sp}}^{{t}_{0} + {t}_{vs}} {P}_{recu} ( t ) dt \qquad {S}_{expanded} = [ \begin{matrix}{E}_{recu , 100 \%} \\ {t}_{sp}\end{matrix} ]$$

In a further preferred embodiment, generating the state vector S_{expanded} comprises (a) calculating a weighted recuperation energy value E_{recu,weighted} by integrating a recuperation power P_{recu}(t) over time t from a current time t₀ within the driving cycle to the end of the driving cycle t_{end}, wherein the recuperation power P_{recu}(t) is temporally weighted with a weighting factor α(t); and (b) generating a state vector S_{expanded} that comprises the weighted recuperation energy value E_{recu,weighted}.

E_{recu,weighted}(t₀)=∫ₜ_{₀}^{t}^{_{end}}α(t)·P_{recu}(t)dt S_{expanded}=[E_{recu,weighted}]

The preferred embodiments of an expansion of the state vector allow different weightings of the predicted recuperation powers over the driving cycle. The last-mentioned embodiment has the advantage that, by virtue of selecting a decreasing weighting factor α(t), recuperation powers that lie further in the future are able to be weighted to a lesser extent, since the occurrence thereof is associated with greater uncertainty. An exponentially decreasing weighting factor α(t) may in particular be used.

In a further preferred embodiment, the reward function adopts a positive value when the battery state of charge (a) is improved and does not exceed a permissible range; and (b) a predicted recuperation energy is able to be stored without the permissible range of the battery state of charge being exceeded in the process; and (c) a reflex has not intervened. Reinforcement learning decisions are thereby implemented only in a region of the state space that has been deemed safe by the reflex. The battery state of charge is also kept in an upper permissible range.

In a further preferred embodiment, the neural network is trained in accordance with a Q-learning algorithm. The Q-learning algorithm has proven to be particularly suitable for the present task.

A second aspect of the invention relates to a device (processor) for performing the method according to the first aspect of the invention.

The features and advantages described in relation to the first aspect of the invention and its advantageous refinement also apply, where technically expedient, to the second aspect of the invention and its advantageous refinement.

Further features, advantages and application possibilities of the invention will become apparent from the following description in connection with the figures.

### BRIEF DESCRIPTION OF THE DRAWINGS

FIG. 1 shows one exemplary embodiment of a method for calculating a recuperation power in an on-board energy system simulation;

FIG. 2 shows one exemplary embodiment of a method for integrating a prediction of recuperation in an energy management system; and

FIG. 3 shows one exemplary embodiment of a reflex-augmented reinforcement learning method in an on-board energy system simulation.

### DETAILED DESCRIPTION OF THE DRAWINGS

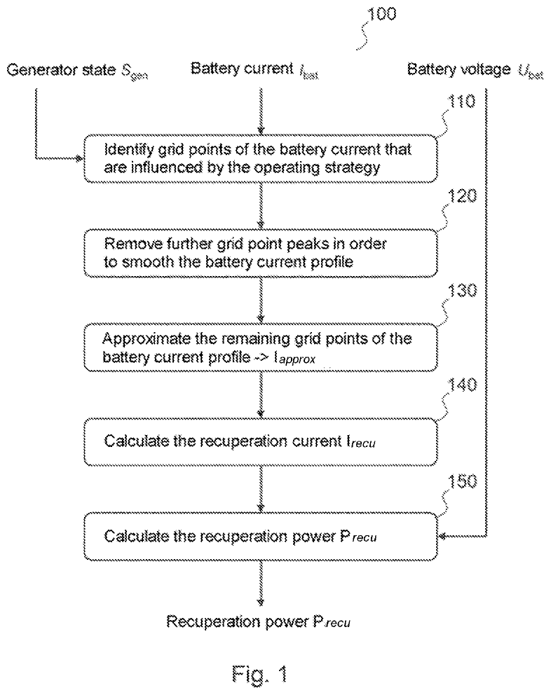

FIG. 1 shows one exemplary embodiment of a method 100 for calculating a recuperation power P_{recu} in an on-board energy system simulation.

The input variables are the generator state S_{gen}, the battery current I_{bat} and the battery voltage U_{bat}. In a method step 110, grid points of the battery current profile that are influenced by the operating strategy of the energy management system are identified and extracted. Further grid point peaks are removed in method step 120 in order to smooth the battery current profile. Next, in method step 130, the battery current profile is approximated with the remaining grid points. Using the approximated battery current profile Iₐₚₚᵣₒₓ, the recuperation current I_{recu} is calculated in accordance with I_{recu}=I_{bat}−Iₐₚₚᵣₒₓ and the recuperation power P_{recu} is calculated in accordance with P_{recu}=U_{bat}·I_{recu}.

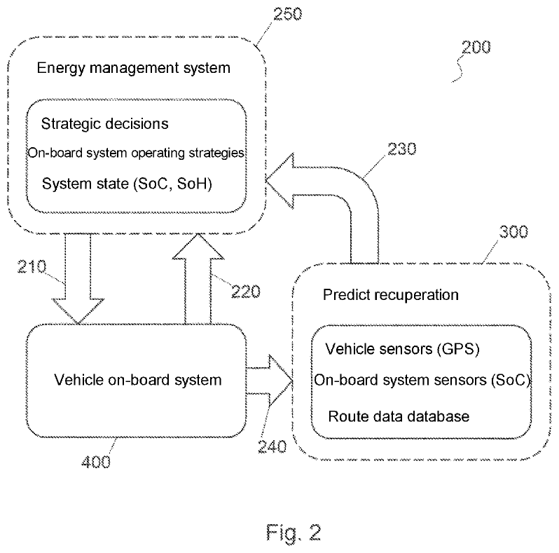

FIG. 2 shows one exemplary embodiment of a method 200 for integrating a prediction of recuperation in an energy management system.

A prediction of recuperation 300 may be determined from sensor data 240 from the on-board system 400 and from route data from a route database and be transmitted to the energy management system 250. This is capable of making strategic decisions on the basis of system state data 220 and a prediction of recuperation 230, for example through reinforcement learning.

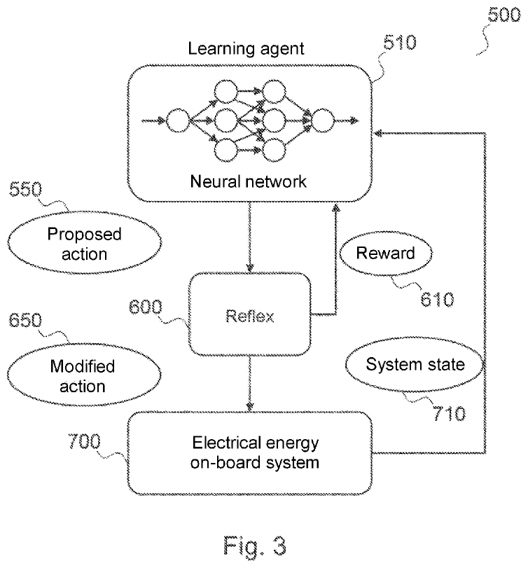

FIG. 3 shows one exemplary embodiment of a reflex-augmented reinforcement learning method 500 in an on-board energy system simulation.

A reflex 600 stabilizes and secures the energy management system by checking and potentially modifying all actions 550 proposed by a learning agent 510. Only an action 650 accepted and potentially modified by the reflex 600 is able to directly influence the state of an on-board energy system 700. The learning agent 510 then receives feedback as to how the action 550 proposed thereby has affected the on-board energy system, in the form of a reward 610, in accordance with a reward function. The operating strategy is thereby oriented to desired optimization targets on the basis of a system state 710 during a learning process. Intervention of the reflex 600 is taken into consideration in the reward function

One exemplary embodiment for the development of a suitable reward function for training an energy management system is shown by the following algorithm.

```
IF reflex has intervened THEN
        R = 0
ELSE
  IF SOC > SOC_crit_max OR SOC < SOC_crit_min THEN
    IF SOC < SOC_crit_min THEN
      IF charge battery THEN
        R > 0
      ELSE
        R = 0
    IF SOC > SOC_crit_max THEN
      IF discharge battery THEN
        R > 0
      ELSE
        R = 0
  ELSE
    IF SOC > SOC_target + Delta
      IF battery discharge THEN
        R > 0
      ELSE
        R = 0
    IF SOC < SOC_target − Delta
      IF battery charge THEN
        R > 0
      ELSE
        R = 0
  IF SOC_target − Delta < SOC <SOC_target + Delta THEN
    IF expected recuperation energy > E_threshold value THEN
      IF battery discharge THEN
        R > 0
      ELSE
        R = 0
    ELSE
      IF keep battery SOC THEN
        R > 0
      ELSE
        R = 0
```

In this case, the constant Delta denotes a deviation of the state of charge SOC from a desired target value. The deviation may for example be 2%. SOC denotes a current state of charge, and SOC target denotes a desired optimum state of charge. This may for example be 80% of the maximum state of charge.

The constant E threshold value may be calculated as follows:

SOC+SOC_through_recu=SOC_target+Delta

SOC_through_recu=SOC_target−SOC+Delta
SOC: Current SOC value
SOC_through_recu: SOC increase caused by Recu
SOC_target: Target SOC, for example 80%
Delta: Delta how far the SOC is allowed to deviate from the target SOC

This means that the battery, in the case of expected recuperation energy, should only be discharged if the required SOC range (SOC_target−Delta<SOC<SOC_target+Delta) would be otherwise be exceeded without discharging.

E_threshold value=SOC_through_recu*Q_battery*U_batt_average
E_threshold value: Energy threshold value
Q_battery: Nominal capacity of the battery
U_batt_average: Average battery voltage across the cycle

1.-10. (canceled)

11. A method for training an energy management system in a simulation of an on-board energy system of a motor vehicle, comprising:
simulating a driving cycle with defined recuperation;
recording state variables of the on-board energy system;
calculating a recuperation power P_{recu} from a recuperation current I_{recu} and a battery voltage U_{bat} in accordance with the following formula:
P_{recu}=U_{bat}·I_{recu};
generating input vectors of a neural network;
generating a reward function; and
training the neural network.

12. The method according to claim 11, wherein determining the recuperation current I_{recu} comprises:
extracting all grid points of a battery current profile I_{bat} that are able to be attributed to decisions of the energy management system and have not been impressed externally on the on-board energy system;
smoothing the battery current profile I_{bat} between remaining grid points (120);
approximating the battery current profile I_{bat} through an approximated battery current profile Iₐₚₚᵣₒₓ between the remaining grid points; and
calculating the recuperation current I_{recu} from the battery current I_{bat} and the approximated battery current Iₐₚₚᵣₒₓ in accordance with the following formula:
I_{recu}=I_{bat}−Iₐₚₚᵣₒₓ.

13. The method according to claim 11, wherein the recuperation current I_{recu} corresponds to the battery current I_{bat}.

14. The method according to claim 11, wherein generating the input vectors S of the neural network comprises:
generating a state input vector Sₙₒᵣₘₐₗ of a neural network that has the following form:
$${S}_{normal} = [ \begin{matrix}Generator degree of use \\ Normalized battery current \\ SoC \\ Battery temperature\end{matrix} ]$$
expanding a state input vector Sₙₒᵣₘₐₗ of the neural network with a state vector S_{expanded}, such that an overall vector S has the following form:
$$S = [ \begin{matrix}{S}_{normal} \\ {S}_{expanded}\end{matrix} ] .$$

15. The method according to claim 14, wherein generating the state vector S_{expanded} comprises:
calculating recuperation energy values E_{recu,x} by integrating a recuperation power P_{recu}(t) over time t, from a current time to within the driving cycle to a time t₀+x·tᵥₛ, wherein x is a percentage share of a look-ahead time tᵥₛ for a limited future consideration of recuperation powers P_{recu}(t), in accordance with the following integral:
$${E}_{recu ′ x} ( {t}_{0} ) = {\int }_{{t}_{0}}^{{t}_{0} + x . {t}_{vs}} {P}_{recu} dt$$
generating a state vector S_{expanded} that comprises at least the recuperation energy values E_{recu,25%}, E_{recu,50%}, E_{recu,75%} and E_{recu,100%} and has the following form:
$${S}_{expanded} = [ \begin{matrix}{E}_{recu , 25 \%} \\ {E}_{recu , 50 \%} \\ {E}_{recu , 75 \%} \\ {E}_{recu , 100 \%}\end{matrix} ] .$$

16. The method according to claim 14, wherein generating the state vector S_{expanded} comprises:
calculating a center of gravity tₛₚ of a power distribution and a predicted recuperation energy value E_{recu,100%} within a look-ahead time tᵥₛ, wherein the center of gravity is that point at which the integral over the recuperation power within the look-ahead time tᵥₛ takes on half the overall recuperation energy in accordance with the following equation:
∫ₜ_{₀}^{t}^{₀}^{t}^{ₛₚ}P_{recu}(t)dt=∫ₜ_{₀}₊ₜ_{ₛₚ}^{t}^{₀}^{+t}^{ᵥₛ}P_{recu}(t)dt
generating a state vector S_{expanded} that comprises the predicted recuperation energy value E_{recu,100%} and the center of gravity tₛₚ of the power distribution and has the following form:
$${S}_{expanded} = [ \begin{matrix}{E}_{recu , 100 \%} \\ {t}_{sp}\end{matrix} ] .$$

17. The method according to claim 14, wherein generating the state vector S_{expanded} comprises:
calculating a weighted recuperation energy value E_{recu,weighted} by integrating a recuperation power P_{recu}(t) over time t from a current time to within the driving cycle to the end of the driving cycle t_{end}, wherein the recuperation power P_{recu}(t) is temporally weighted with a weighting factor α(t), in accordance with the following integral:
$${E}_{recu , weighted} ( {t}_{0} ) = {\int }_{{t}_{0}}^{{t}_{end}} α ( t ) \cdot {P}_{recu} ( t ) dt$$
generating a state vector S_{expanded} that comprises the weighted recuperation energy value E_{recu,weighted}, and has the following form:
S_{expanded}=[E_{recu,weighted.}

18. The method according to claim 11, wherein the reward function adopts a positive value when the battery state of charge:
(i) is improved and does not exceed a permissible range, and
(ii) a predicted recuperation energy is able to be stored without the permissible range of the battery state of charge being exceeded in the process, and
(iii) a reflex has not intervened.

19. The method according to claim 11, wherein the neural network is trained in accordance with a Q-learning algorithm.

20. A device for training an energy management system in a simulation of an on-board energy supply system of a motor vehicle, comprising:
a processor and associated memory configured to:
simulate a driving cycle with defined recuperation;
record state variables of the on-board energy system;
calculate a recuperation power P_{recu} from a recuperation current I_{recu} and a battery voltage U_{bat} in accordance with the following formula:
P_{recu}=U_{bat}·I_{recu};
generate input vectors of a neural network;
generate a reward function; and
train the neural network.
